(19) United States
(12) Patent Application Publication
(10) Pub. No.: US 2004/0126733 A1
(43) Pub. Date: Jul. 1, 2004

(54) Dental extruder system

(76) Inventor: Jorn Ronvig, Daugaard (DK)

Correspondence Address: MERCHANT & GOULD PC, P.O. BOX 2903, MINNEAPOLIS, MN, 55402-0903, US

(21) Appl. No.: 10/467,998

(22) PCT Filed: Feb. 8, 2002
(86) PCT No.: PCT/DK02/00093

(30) Foreign Application Priority Data
Feb. 14, 2001 (DK) PA 2001 00245

(51) Int. Cl. A61C 5/04

(52) U.S. Cl. 433/90

(57) ABSTRACT

This invention relates generally to a dental device for the placement or dental materials, and more particularly to a dental syringe device having an improved barrel front end portion for the extrusion of dental cartridges containing dental materials. A rod in the barrel front is forced against the cartridge is arranged in the device maintaining the cartridge in position during use.

This invention relates generally to a dental device for the placement of dental materials, and more particularly to a dental syringe device having an improved barrel front end portion for the extrusion of dental cartridges containing dental materials.

### BACKGROUND

Various types of dental materials are prepackaged in unit dose capsules or cartridges. Single component dental materials such as light activated composite resin material have been prepackaged in unit dose capsules, e.g. of the type disclosed in U.S. Pat. Nos. 3,581,399; 4,963,093; 5,122,057; 4,391,590 and 4,767,326. These patented capsules and others like them are generally characterized as having a cylindrical body portion having a collar or flange circumscribing one end thereof and having an angled discharge nozzle connected to the other end thereof.

The content of the cartridge is normally expelled by use of a manual extruder for dispensing viscous dental material within a prepared tooth. Initially, a “snap-fit” front end was believed to be desirable in a dental extrusion device because of its inherent ease of use. A dental cartridge containing dental material could easily be snapped into the front end of a dental extruder. Examples of such “snap-fit” front end portions of a dental extruder are disclosed in U.S. Pat. Nos. 4,330,280 and 4,384,853. Therein disclosed is a dental extruder having flexible side walls that permit a cartridge to be snapped into the front end. The width of the front end opening is slightly less than the outside lateral width or diameter of a cartridge. Therefore, the insertion of the cartridge causes the side walls to flex, resulting in the “snap-fit”. While the “snap-fit” front end dental extruders are relatively easy to use, the inherent flexibility necessary to provide a “snap-fit” results in a potentially hazardous condition. Some dental materials that are extremely viscous and placed into dental cartridges for extrusion with a dental extruder result in extremely high forces being applied to the front end. These high forces, when applied to a “snap-fit” front end often causes the flexible side walls to be forcibly spread apart during use. This results in the dental cartridge becoming wedged within the front end or even more seriously, the cartridge unintentionally shooting from the front end during use. This creates a potentially hazardous situation in that during the normal use, the front end of the dental extruder is inside a patient's mouth. Additionally, constant flexing of the side walls results in fatigue and often breakage. U.S. Pat. No. 5,061,179 discloses a dental extruder and cartridge attempting to overcome some of the problems encountered with the “snap-fit” front end. Therein disclosed is a dental extruder and cartridge having interlocking bearing surfaces. The interlocking bearing surfaces helped prevent the flexible side walls from spreading apart during extrusion of the more viscous dental materials. While this helped solve some of the problems inherent with a “snap-fit” front end, it did not solve the fatigue problem of repeated use and flexing of the side walls or the stress placed on the cartridge by the side walls.

U.S. Pat. No. 5,489,207 discloses another dental extruder, wherein the cartridge is put into a longitudinal opening in the front end of the extruder and then pushed forwards to that the flange of the cartridge gets into frictional engagement with side walls of the front end of the extruder. The cartridge is released by pushing the cartridge backwards out of the extruder opening. However this way of releasing the cartridge implies a several drawbacks. First of all the nozzle end of the cartridge, which is contaminated after use with dental material as well as possibly also saliva, blood etc. from the patient, must be touched thereby exposing the dentist or his helpers to the potentially hazardous material. Furthermore, the strength of the frictional engagement depends largely on the accuracy of the external diameter of the flange of the cartridge, which is of course subject to variation.

Therefore, there is a need for an easy loading and releasing dental extruder with high strength and durability that can safely and confidently be used with dental materials.

### SUMMARY OF THE INVENTION

The present invention relates to an extruder system for use with dental materials comprising,

a barrel, said barrel having a front end and a rear end, said front end having side wall forming a chamber for receiving a cartridge comprising the dental material, said cartridge comprising a body portion and an externally extending flange connected to said body portion,

said chamber having a longitudinally extending opening adjacent said front end, said opening extending axially at least partially along said chamber, said front end terminating in a front opening, said chamber having a cartridge body receiving portion and a cartridge flange receiving portion thereby dividing the opening into an with a cartridge body receiving portion opening and a cartridge flange receiving portion opening, at least a part of said cartridge body receiving portion having a smaller internal diameter than the external diameter of said flange,

said barrel further comprising a rod capable of moving axially in said barrel and capable of exerting a pressure force on the flange of a cartridge towards the front and of the barrel, and a plunger slidably mounted within said barrel,

said extruder system further comprising a handle means connected to said barrel and contacting said plunger for providing a physical advantage in advancing said plunger.

Another aspect of the invention concerns a barrel for an extruder system for use with dental materials.

In yet a further aspect the invention describes a method for filling a tooth with dental material comprising,

providing a cartridge filled with dental material, said cartridge comprising a body portion and an externally extending flange connected to said body portion, as well as a central throughout the cartridge bore filled with dental material, and in the end opposing the flange, a nozzle for expelling the dental material,

providing a dental extruder, arranging the cartridge in the chamber of dental extruder, and allowing the rod to move forwards td exert a forwards pressure against the flange,

activating the plunger to expel some or all of the dental material into the tooth.

### DRAWINGS

FIG. 1 shows a side view of the dental extruder

FIG. 2 shows a partial side view of the dental extruder

FIG. 3 shows the front end of the barrel of the dental extruder in greater detail

FIG. 4 shows the, barrel of the dental extruder from above

FIG. 5 is an exploded view of the dental extruder

FIG. 6 shows the front end of the barrel having the rod retracted

FIG. 7 shows the front end of the barrel with cartridge positioned in the chamber

FIG. 8 shows a cartridge for use with the dental extruder

FIG. 9 shows another embodiment of the dental extruder

FIG. 10 shows another embodiment of the dental extruder

FIG. 11 shows the distal end of the dental extruder

FIG. 12 shows the proximal end of the dental extruder.

FIG. 13 shows another embodiment of the rod

FIG. 14 shows another embodiment of the dental extruder in greater detail.

### DETAILED DESCRIPTION OF THE INVENTION

The present invention relates to a dental extruder or syringe for extruding dental material from a cartridge, said syringe preferably being for manually extruding said material. The extruder in general comprises a barrel constructed to receive the cartridge as well as a handle means providing sufficient grip to hold the extruder and also providing means for activating the extruder in order to discharge the dental material from the cartridge.

The cartridge discussed in this context is of a conventional construction, comprising essentially a body portion to define a reservoir or chamber for containing the dental material and which is open at one end. Disposed about the body portion adjacent the open end thereof is a laterally extending flange or collar. On the other end of the cartridge body portion is a discharge nozzle. Generally, the nozzle is rendered readily flexible so that it can be bent to a suitable working angle, and/or may be formed so as to be angularly disposed relative to the longitudinal axis of the cartridge body portion to provide for a proper working angle. It will be understood that the open end of the body portion is sealed by a displaceable plug.

The extruder system may also be used with mixing cartridges generally formed and sized so as to contain two or more components which are maintained in a segregated state until the cartridge is to be used, at which time the cartridge is placed in an agitator to effect the mixing of the material components contained therein. Such cartridges have been used to package various amalgam type dental materials, glass ionomer and other multiple component dental material that require mixing in situ within the cartridges before using. It is also contemplated that such cartridge may also be used to package single component dental material that are best applied by a syringing procedure, e.g. impression materials, composites and the like.

The dental material in cartridge is generally very viscous requiring high extrusion pressures, resulting in large longitudinal forces being placed on the cartridge during extrusion.

The extruder system comprises a barrel, said barrel having a front end and a rear end is provided with an internal bore that extends through the barrel. The barrel is constructed to receive said cartridge in the front end, in that said front end has side walls forming a chamber for receiving the cartridge comprising the dental material.

In a preferred embodiment the barrel walls are produced from a material being rigid, durable and substantially not flexible, in order to maintain their shape after several rounds of uses. In particular the barrel walls forming the chamber are produced from an inflexible and rigid material. Said material may be any suitable material, that is a material capable of enduring repeated autoclaving, such as a metal, for example stainless steel, or a plastic, such as a polyester plastic or a polypropylene plastic. Many plastics have these characteristics. A fully aromatic polyester plastic such as Vectra liquid crystal polymer has these characteristics.

The barrel may have any suitable form and cross-section; such as rectangular, triangular or cylindrical cross-section, it is however preferred that the barrel is cylindrical.

The chamber has a longitudinally extending opening adjacent said front end, said opening extending axially at least partially along said chamber. In a preferred embodiment said opening extends along the full length of said chamber. The chamber terminates in a front opening for allowing the nozzle and at least some portion of the cartridge body to extends through the front opening, when the cartridge is positioned in the chamber ready for use.

The chamber is divided into a cartridge body receiving portion and a cartridge flange receiving portion, wherein the cartridge flange receiving portion corresponds to the part of the chamber having dimensions capable of housing the flange. Thereby the opening of the chamber may be divided into a cartridge body receiving portion opening and a cartridge flange receiving portion opening, respectively.

In order to position and maintain the flange in the flange receiving portion at least a part of said cartridge body receiving portion has a smaller internal diameter than the external diameter of said flange thereby preventing the flange to enter said part of the cartridge body receiving portion of the chamber. Thus, the barrel may comprise, a shoulder circumscribing at least a portion of the internal circumference of the front end of said barrel for preventing the flange from passing into the cartridge body receiving portion. In another embodiment the cartridge body receiving portion tapers slightly towards the front end. In yet another embodiment an Inturned flange projects inwardly from the side walls of the cartridge body receiving portion. It is preferred that the part of said cartridge body receiving portion having a smaller internal diameter is either a shoulder or an inturned flange, presenting a supporting or bearing surface for the flange to be pressed against.

It is preferred that the lateral width of said cartridge flange receiving portion opening is greater than the diameter of the flange of said dental cartridge in order to reduce the pressure on the cartridge, when it is inserted into the chamber.

Thereby the extruder system for use with dental materials according to the invention, allows said dental cartridge to be put into the front end by the body portion passing through an opening in the cartridge body receiving portion and the flange passing through an opening in the flange receiving portion, said cartridge being (locked into position by a rod exerting a forwards pressure force on the flange of the cartridge. By the term “forwards” means a movement towards the front end of the barrel, and “backwards” means towards the rear end of the barrel.

Furthermore, in order to reduce a lateral pressure force between the cartridge and the side walls of the chamber, it is preferred that the internal diameter of the cartridge flange receiving portion is at least slightly larger than the external diameter of the flange of the cartridge. Since the cartridge is held in place by the rod, it is not necessary that a tight fit between the side walls and the cartridge exists, which allows for variations among the cartridges to be used in a dental extruder according to the invention.

To avoid accidental release of the cartridge when it is positioned in the chamber it is preferred that the side walls correspond to a major part of the circumference of the chamber, such as corresponding to a part of the circumference of the chamber in the range of from 180° to 240°, such as from 190° to 210°.

The barrel further comprises a rod capable of moving axially in said barrel and capable of exerting a pressure force on the flange of a cartridge towards the front and of the barrel thereby pressing the flange towards to part of the said cartridge body receiving portion having a smaller internal diameter as discussed above.

The rod may be partially movable in said barrel, such as a rod made from a compressible material capable of being compressed to allow the cartridge to be positioned in the chamber and then exerting a forwards pressure force on the flange when the rod is relaxed.

In another embodiment the rod is retractable by means of a handle and then capable of being pressed forwards after insertion of the cartridge.

In yet another preferred embodiment the rod is spring biased for exerting a forwards pressure force on the flange of a cartridge when positioned in the chamber.

The rod may attain any suitable form capable of functioning to exert the pressure force needed. The rod may exert the pressure force to a part of the flange or to the whole circumference of the flange, the latter being the preferred embodiment in order to secure the cartridge in position. The rod is preferably a tubular rod having a circumference adapted to the circumference of the flange. It is preferred that the rod is a tubular rod having an at least substantially centred bore allowing the plunger to slide within the rod.

In a preferred embodiment a peripheral distal edge of the rod is projected distally defining a central depressed area of the distal end of the rod. Thereby the cartridge fits into the depressed central part of the rod when arranged in the chamber and any accidental sidewards release of the cartridge is avoided. In this embodiment when the cartridge is to be released the tip of the cartridge is pressed sidewards in relation to the chamber, allowing the proximal part of the cartridge to slip out from the depressed area of the rod.

When the pressure force is effected by a spring, such as a coil spring, it is preferred that the front end of the barrel is separable from the rear end of the barrel, whereby an internal spring chamber may be defined in the barrel for housing the spring, said internal spring chamber being accessible when the front end of the barrel is separated from the rear end of the barrel.

In the bore of the barrel a plunger is slidably mounted. The plunger is adapted to engage the rear end of the cartridge, often sealed with a plug, and furthermore, the plunger is dimensioned to fit into the reservoir within the cartridge, to effect displacement of the plug for extruding the dental material from the cartridge when the extruder is activated. The plunger may be provided with teeth or flanges in the rear end to enable engagement with the handle means.

The plunger may be adapted to be manually retracted from the cartridge after discharging the dental material, or the plunger biased with a spring, so that it is retracted from the flange opening when not advanced by the handle means.

In a preferred embodiment the plunger is sliding within a tubular rod being spring-biased, and the spring capable of exerting the pressure force of the rod also acts to effect the retraction of the plunger when the handle is not activated.

Said extruder system further comprising a handle means connected to said barrel and contacting said plunger for providing a physical advantage in advancing said plunger.

In one embodiment the handle means provides a mechanical advantage, examples of which are shown in U.S. Pat. No. 4,330,280, U.S. Pat. No. 4,384,853, U.S. Pat. No. 5,061,179 and U.S. Pat. No. 5,489,207 which are hereby incorporated by reference.

The handle means preferably comprises a cam surface for providing a forwards advancing movement of the plunger. In a preferred embodiment the handle means comprises a grip portion and a lever, said grip portion being attached to the barrel. The lever is connected to the grip portion through a pivot pin through a bore in the grip portion. The lever comprises a cam surface to engage the plunger whereby the plunger is moved forwards when the lever is squeezed against the grip portion. A coil spring may be disposed about the rear portion of the plunger as discussed above to impart a spring bias thereto to return the plunger and lever to its inoperative position when the squeezing pressure on the lever is released and to retract the plunger out of the loading area.

To prevent pinching, when the lever is squeezed toward the grip portion, a suitable stop means may be provided to limit the movement of the lever relative to the grip portion. Such stop means may be in the form of aligned complementary abutments projecting from the grip portion and lever to limit the relative movement therebetween.

In another embodiment the handle means comprises means for providing a hydraulic advantage of the plunger.

The extruder system is preferably designed as a manual system, but may also be operated through an automatic hydraulic system. The system may also be an automatic system driven by an electromotor, e.g. coupled to a screw.

In another aspect the invention relates to the barrel for the extruder system for use with dental materials, said barrel having the characteristics defined above in relation to the barrel.

In yet another aspect the invention relates to a method for filling a tooth with dental material comprising providing a cartridge filled with dental material, said cartridge comprising a body portion and an externally extending flange connected to said body portion, as well as a central bore throughout the cartridge filled with dental material, and in the end opposing the flange, a nozzle for expelling the dental material, providing a dental extruder as defined above, arranging the cartridge in the chamber of dental extruder, and allowing the rod to move forwards to exert a forwards pressure against the flange, and activating the plunger to expel some or all of the dental material into the tooth.

In operation, the body portion of a dental cartridge or ampule is pressed against the rod and thereby laid into the chamber through the longitudinal opening. The cartridge is then positioned by the rod advancing the cartridge, so that a bearing surface of the flange preferably mates with a bearing surface of the chamber as discussed above or the flange is pressed into a frictional engagement with the chamber wall.

Reference Signs

1 dental extruder

2 barrel

3 handle means

4 front end of the barrel

5 rear end of the barrel

6 chamber

7 side wall

8 cartridge body receiving portion

9 flange receiving portion

10 shoulder

11 rod

12 central bore of rod

13 plunger

14 spring

15 Internal spring chamber

16 plunger flange

17 cam surface

18 lever

19 pivot pin

19a supportive bush for pivot pin

20 bore

21 grip portion

22 cartridge

23 cartridge body

24 flange

25 nozzle end

26 bearing surface

27 piston rod

28 spring

29 pressure foot

30 M2×2.5 Pinol screw

31 spring

32 threaded bushing

33 middle part of the barrel

34 peripheral edge of rod

### DETAILED DESCRIPTION OF THE DRAWINGS

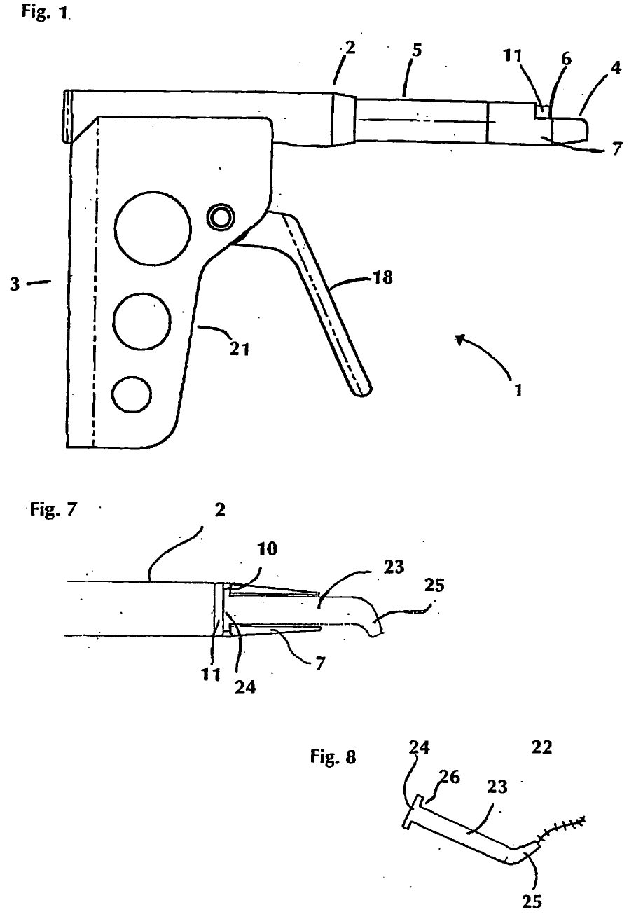

FIG. 1 shows the dental extruder 1 having a barrel 2 and a handle means 3. The barrel 2 is divided into a front end 4 and a rear end 5. The front end 4 of the barrel 2 comprises side walls 7 defining a chamber 6 for receiving a cartridge filled with dental material. A longitudinal opening in the side walls allows the cartridge to be inserted into the chamber 6. The front end 4 terminates in a front opening allowing the cartridge to partially protrude from the barrel when the cartridge is positioned in the chamber 6. A rod 11 is arranged in the barrel 2 exerting a forwards pressure force. The handle means 3 comprises a grip portion 21 and a lever 18 said grip portion 21 and lever 18 being operably linked so that a squeezing force forcing the lever 18 towards the grip portion 21 via a plunger causes dental material to be discharged from a cartridge positioned in the chamber 6.

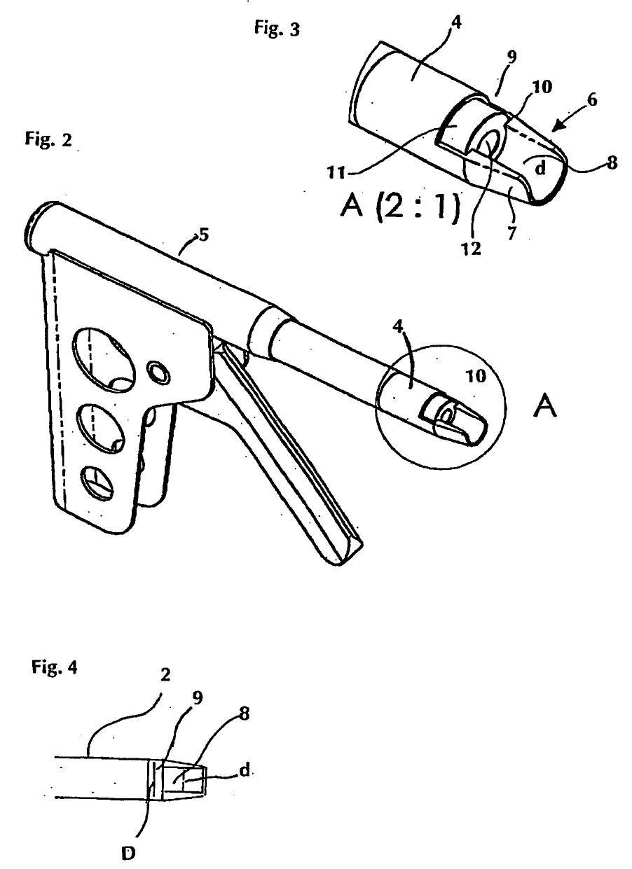

FIG. 2 shows the dental extruder 1 of FIG. 1 in a partial side view, whereby it is possible to see the rod 11 pressing against shoulder 10 of the chamber. Said shoulder 10 preventing the rod 11 from being forced to far towards the open end of the front end 4 of the barrel 2.

FIG. 3 shows the front end 4 of the barrel 2 in greater detail. The chamber 6 is divided into a cartridge receiving portion 8 and a flange receiving portion 9, whereby the longitudinal opening of the chamber 6 is divided into a cartridge receiving portion opening and a flange receiving portion opening. The shoulder 10, which will provide most of the support for the longitudinal forces on the cartridge during extrusion, can more clearly be seen. A rod 11 is positioned protruding into the front end 4 of the barrel 2 pressing against shoulder 10. The rod 11 having a central bore 12 allowing a plunger to slide within the rod 11. The side wall 7 corresponds to a major part of the circumference of the chamber 6.

FIG. 4 shows the barrel 2 seen from above. The lateral width d of cartridge body opening is substantially constant along its length. This lateral width is preferably equal to or slightly greater than the outside diameter of the body portion of a cartridge intended to be inserted into the dental extruder 1. Adjacent to the rear of the cartridge body opening is the flange opening. The flange opening has a lateral width D greater than the lateral width of cartridge body opening. The lateral width of the flange opening is preferably greater than the outside diameter of the flange portion of a cartridge.

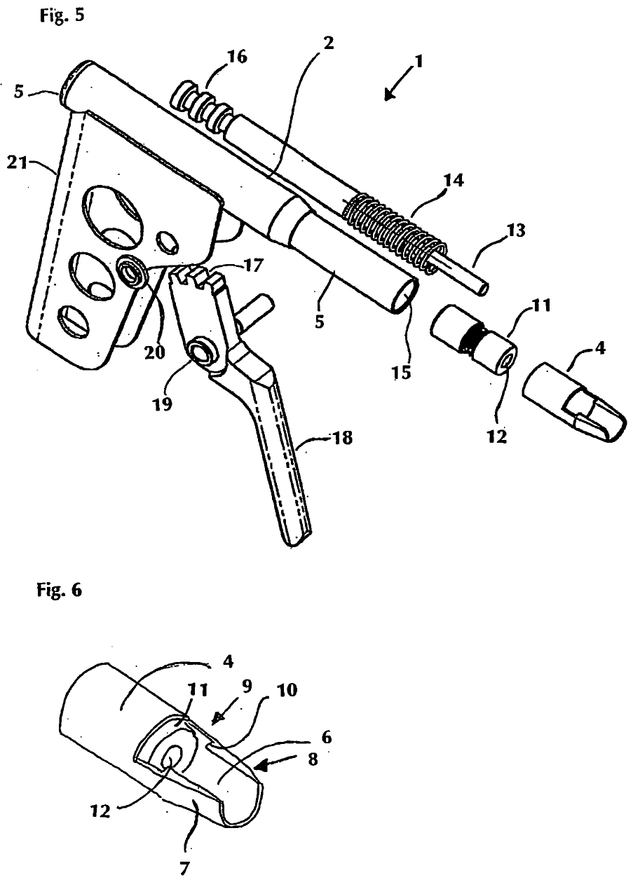

FIG. 5 shows an exploded view of the dental extruder 1. The barrel 2 is separated into the front end 4 and the rear end 5 exposing an axial bore through the barrel 2. In the axial bore a plunger 13 is arranged provided with a coil spring 14 to be positioned in an internal spring chamber 15 when the front end 4 is connected to the rear end 5. A rod 11 provided with a substantially centred bore 12 is adapted to fit into the front end 4 of the barrel 2 protruding into the chamber 6. The coil spring 14 exerts a forwards pressure force on the rod 11 when the front end 4 is connected to the rear end 5. Furthermore, the coil spring biases the plunger 13 whereby the (plunger 13 is forced to a retracted position unless when being advanced by the handle means 3. The handle means 3 comprises a lever 18 capable of being connected to the grip portion 21 through a pivot pin 19 in bore 20. The lever 18 has a cam surface 17 capable of fitting into the rear part of the plunger 13 provided with flanges 16. The plunger 13 and cam surface 17 are configured or adapted so that when the lever 18 is pushed back by the spring 14, the plunger 13 always maintains contact with the cam surface 17. In this position the front end of the plunger 13 is behind the flange. This permits easy removal of the cartridge without having to remove the plunger 13 from contact with the cam surface 17 and the lever 18.

FIG. 6 shows the front end 4 of the barrel 2 wherein the rod 11 is partially retracted to show a part of the flange receiving portion 9 of the chamber 6. The rod 11 may be retracted by means of a handle, but normally the rod 11 is forced backwards by the cartridge, when positioning the cartridge in the chamber 6.

FIG. 7 shows a cartridge 22 positioned in the chamber 6. The inner surface of cartridge receiving portion opening has a lateral width greater than the lateral width of the cartridge 22. This permits easy loading of the cartridge 22 into the front end 4 of the dental extruder 1. Shoulder 10 prevents further forward movement of the cartridge 22 during extrusion. After the cartridge 22 is securely seated against shoulder 22, the plunger may be advanced and the extrusion begins forcing viscous dental material through nozzle of the cartridge 22. After extrusion, the plunger is pushed back by the spring 14 permitting the cartridge 22 to be pushed out of the chamber 6, for example by pressing the nozzle part of the cartridge 22 against a solid surface. The cartridge is then easily lifted out of the front end 4.

FIG. 8 shows a cartridge 22 having a cartridge body 23, a flange 24 and a nozzle end 25. The flange 24 has a front bearing surface 26. The front bearing surface 26 is adapted to mate with the shoulder 10. The nozzle end 25 is sealed with a sealing, such as a cap.

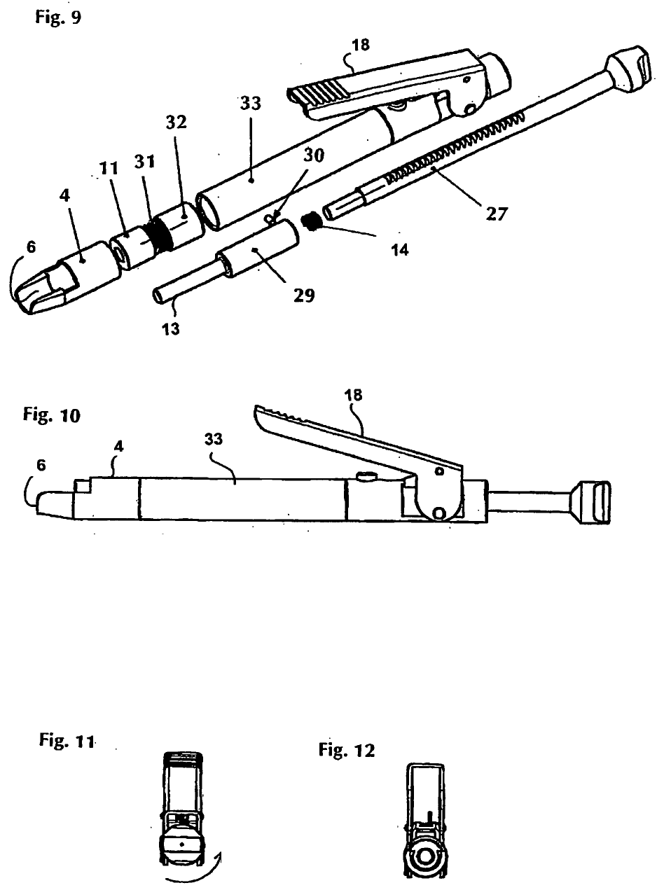

FIG. 9 shows an exploded view of another embodiment of the dental extruder according to the invention. The barrel 33 is separated into the front end 4 and the rear end exposing an axial bore through the barrel. In the axial bore a plunger 13 is arranged provided with a coil spring 14 to be positioned in an internal spring chamber when the front end 4 is connected to the rear end. A rod 11 provided with a substantially centred bore is adapted to fit into the front end 4 of the barrel protruding into the chamber 6. The threaded bushing 32 is inserted into the barrel 33, when the front end 4 and the rear end are connected. The coil spring 14 exerts a forwards pressure force on the rod 11 when the front end 4 is connected to the rear end. Furthermore, the coil spring biases the plunger 13 whereby the plunger 13 is forced to a retracted position unless when being advanced by the handle means. The handle means comprises a lever 18 capable of being connected to the barrel 33. The plunger 13 is connected to pressure foot 29 capable of receiving a spring 28 biasing screw 30. A pawl (not shown) on the lever 18 enters sequentially the recesses of piston rod 27 thereby forcing the piston rod towards the rod 11. The screw 30 acts as a blocking screw so the piston rod 27 does not retract from the position when the pawl moves from one recess to the next.

In FIG. 10 the dental extruder shown in FIG. 9 is shown in a side view having the level raised ready for use.

FIG. 11 show a distal view of the dental extruder of FIG. 9, and FIG. 12 show a proximal view of the dental extruder of FIG. 9.

In FIG. 13 a preferred embodiment of the rod is shown. The peripheral distal edge 34 of the rod 11 is projected distally defining a central depressed area of the distal end of the rod having a central bore 12. The peripheral edge 34 abuts the shoulder 10, when the rod 11 is forced distally. A cartridge arranged in the cartridge body receiving portion has its flange fitting into the depressed area of the rod 11. Preventing that the cartridge accidentally is released during use.

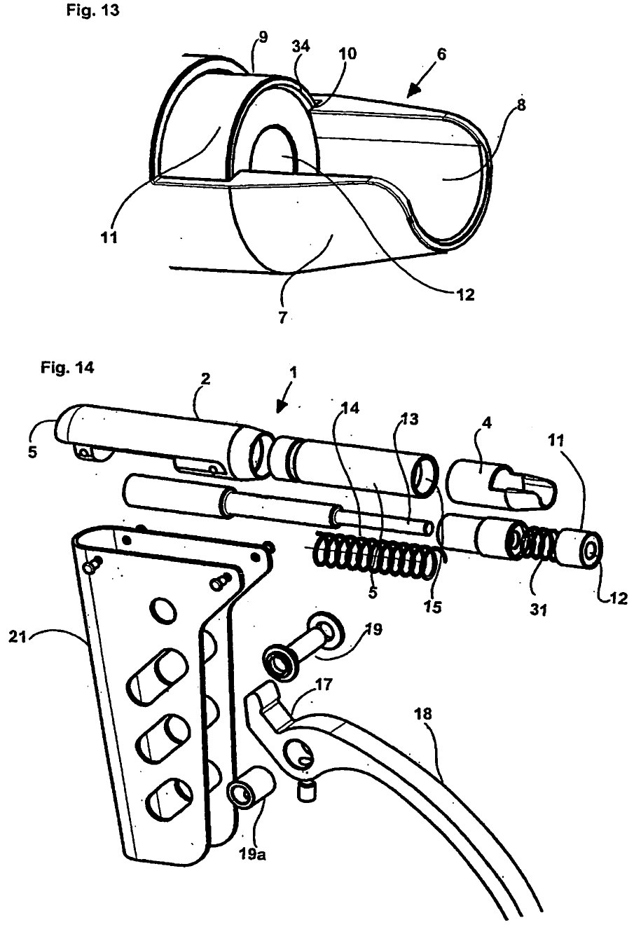

FIG. 14 shows an exploded view of the dental extruder 1. The barrel 2 is separated into the front end 4 and the rear end 5 exposing an axial bore through the barrel 2. In the axial bore a plunger 13 is arranged provided with a coil spring 14 to be positioned in an internal spring chamber 15 when the front end 4 is connected to the rear end 5. A rod 11 provided with a substantially centred bore 12 is adapted to fit 10 into the front end 4 of the barrel 2 protruding into the chamber 6. The rod 11 is divided into two parts by a spring 31. The coil springs 14 and 31 exert a forwards pressure force on the rod 11 when the front end 4 is connected to the rear end 5. Furthermore, the coil spring biases the plunger 13 whereby the plunger 13 is forced to a retracted position unless when being advanced by the handle means 3. The handle means 3 comprises a lever 18 capable of being connected to the grip portion 21 through a pivot pin 19 supported by bushing 19a in bore 20. The lever 18 simply exerts a pressure force on the proximal end of rod 13, when the lever is activated.

It should now be appreciated, in view of the foregoing description, that the present invention provides an ease of insertion and secure holding of a dental cartridge that has not previously been possible with prior dental extruders or syringes. Furthermore, the present invention provides an easy release of the cartridge without handling the nozzle end with for example the hands.

Although the preferred embodiments have been illustrated and described, it will be obvious to those skilled in the art that various modifications and variations may be made without departing from the spirit and scope of this invention.

1. An extruder system for use with dental materials comprising
a barrel, said barrel having a front end and a rear end, said front end having side wall forming a chamber for receiving a cartridge comprising the dental material, said cartridge comprising a body portion and an externally extending flange connected to said body portion,
said chamber having a longitudinally extending opening adjacent said front end, said opening extending axially at least partially along said chamber, said front end terminating in a front opening, said chamber having a cartridge body receiving portion and a cartridge flange receiving portion thereby dividing the opening into a cartridge body receiving portion opening and a cartridge flange receiving portion opening, at least a part of said cartridge body receiving portion having a smaller internal diameter than the external diameter of said flange,
said barrel further comprising a rod capable of moving axially in said barrel and capable of exerting a pressure force on the flange of a cartridge towards the front and of the barrel, and a plunger slidably mounted within said barrel,
said extruder system further comprising a handle means connected to said barrel and contacting said plunger for providing a physical advantage in advancing said plunger.

2. The extruder system for use with dental materials according to claim 1, wherein the barrel comprise a shoulder circumscribing at least a portion of the internal circumference of the front end of said barrel for preventing the flange from passing into the cartridge body receiving portion.

3. The extruder system for use with dental materials according to claim 1 or 2, wherein the rod is spring biased for exerting a forwards pressure force on the flange of a cartridge when positioned in the chamber.

4. The extruder system for use with dental materials according to any of the preceding claims, wherein the rod is a tubular rod having an at least substantially centred bore allowing the plunger to slide within the rod.

5. The extruder system for use with dental materials according to any of the preceding claims, wherein barrel walls are produced from an inflexible, rigid material.

6. The extruder system for use with dental materials according to any of the preceding claims, wherein the lateral width of said cartridge flange receiving portion opening is greater than the diameter of the flange of said dental cartridge.

7. The extruder system for use with dental materials according to any of the preceding claims, whereby said dental cartridge is put into the front end by the body portion passing through an opening in the cartridge body receiving portion and the flange passing through an opening in the flange receiving portion, said cartridge being locked into position by the rod exerting a forwards pressure force on the flange of the cartridge.

8. The extruder system for use with dental materials according to any of the preceding claims, whereby the internal diameter of the cartridge flange receiving portion is at least slightly larger than the external diameter of the flange of the cartridge.

9. The extruder system for use with dental materials according to any of the preceding claims, wherein the barrel is cylindrical.

10. The extruder system for use with dental materials according to any of the preceding claims, wherein the side walls correspond to a major part of the circumference of the chamber.

11. The extruder system for use with dental materials according to claim 10, wherein the side walls correspond to a part of the circumference of the chamber in the range of from 180° to 240°, such as from 190° to 210°.

12. The extruder system for use with dental materials according to any of the preceding claims, wherein the front end of the barrel separable from the rear end of the barrel.

13. The extruder system for use with dental materials according to claim 12, wherein an internal spring chamber is defined in the barrel for housing a rod spring, said internal spring chamber being accessible when the front end of the barrel is separated from the rear end of the barrel.

14. The extruder system for use with dental materials according to any of the pre ceding claims, wherein the handle means provides a mechanical advantage.

15. The extruder system for use with dental materials according to any of the preceding claims 1-13, wherein the handle means provides a hydraulic advantage.

16. The extruder system for use with dental materials according to claim 1, said system being a manual system.

17. The extruder system for use with dental materials according to any of the preceding claims, wherein the handle means comprises a cam surface for providing a forwards advancing movement of the plunger.

18. The extruder system for use with dental materials according to any of the pre ceding claims, wherein the plunger is biased with a spring, so that it is retracted from the flange opening when not advanced by the handle means.

19. A barrel for an extruder system for use with dental materials, said barrel having the characteristics defined in any of the claims 1-18.

20. A method for filling a tooth with dental material comprising,
providing a cartridge filled with dental material, said cartridge comprising a body portion and an externally extending flange connected to said body portion, as well as a central throughout the cartridge bore filled with dental material, and in the end opposing the flange, a nozzle for expelling the dental material,
providing a dental extruder as defined in any of claim 1-18, arranging the cartridge in the chamber of dental extruder, and allowing the rod to move forwards to exert a forwards pressure against the flange,
activating the plunger to expel some or all of the dental material into the tooth.
